(19) United States
(12) Patent Application Publication
(10) Pub. No.: US 2010/0173652 A1
(43) Pub. Date: Jul. 8, 2010

(54) METHOD FOR PAGING A MS IN A MIXED DEPLOYMENT

(75) Inventors: Anshuman NIGAM, Bangalore (IN); Hyun-Jeong KANG, Seoul (KR); Jae-Hee CHO, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/652,950

(22) Filed: Jan. 6, 2010

(30) Foreign Application Priority Data
Jan. 6, 2009 (IN) 26/CHE/2009
Jan. 6, 2010 (IN) 26/CHE/2010

(51) Int. Cl. H04W 68/00

(52) U.S. Cl. 455/458

(57) ABSTRACT

Method for paging a MS in a mixed deployment of femto paging areas and macro paging areas in the network is provided. The presence information of the MS is tracked using at least two paging areas when the MS is in a first zone, wherein the first zone is overlapped by a femto paging area and a first macro paging area and the MS is subscribed to a set of CSG femto cells that are allowed for the MS in the femto paging area. The two paging areas are the femto paging area and the first macro paging area. The presence information of the MS is received by the network when the MS moves from the first zone to a second zone, wherein the second zone is overlapped by the femto paging area and a second macro paging area. The network, based on the received presence information, pages the MS only in a subset of the CSG femto cells that are allowed for the MS in the second zone.

### PRIORITY

This patent application claims priorities from the Indian provisional patent application number 26/CHE/2009, filed on Jan. 6, 2009 entitled “PAGING MECHANISM IN MIXED DEPLOYMENT OF FEMTOCELLS AND MACRO CELLS” and the Indian complete patent application number 26/CHE/2009, filed on Jan. 6, 2010 entitled “METHOD FOR PAGING A MS IN A MIXED DEPLOYMENT” which are hereby incorporated in its entirety.

### FIELD OF THE INVENTION

The present invention, in general, relates to paging in a telecommunication system, and in particular, to a method of paging in a mixed deployment of femto cells and macro cells in a telecommunication system.

### BACKGROUND OF THE INVENTION

For efficient paging of a MS in a ‘3GPP telecommunication network’ or an ‘IEEE802.16m network’ (herein after both as ‘network’) the cells (or the BSs) are grouped into a ‘paging area’ (herein after as ‘PA’). A PA is defined as a collection of radio transmitters and receivers, commonly known as ‘Base Station’(s) (herein after as ‘BS’), in which the MS is paged. In a legacy network, the PAs are formed of legacy cells and are termed as macro PAs. Whenever a MS of such a network moves into a PA it informs the network (usually, using the ‘Paging Controller’ (herein after as ‘PC’) of the network) by a procedure known as location update. Additionally, introduction of new types of cells, such as femtocells, picocells or micro cells, that are significantly smaller compared to the legacy macro cells in the network and are formed to cater to special and more advanced services to consumers, has given rise to a PA called femto PA. The femto PA may comprise of one or more ‘Closed Subscriber Group’ (herein after as CSG) and/or non-CSG femto cells. The CSG and/or non-CSG femto cells may be contiguously or non-contiguously spread over a single or multiple macro PAs giving rise to a mixed deployment (or design) of both the legacy macro PAs and the femto PAs in the network.

The existing paging mechanisms for a macro only deployment are not suitable for such a mixed deployment considering the unwanted paging load and frequency of location updates that the existing paging mechanisms would require. This necessitates a method for improved paging mechanism in such a mixed deployment in the network.

### SUMMARY OF THE INVENTION

This section should not be construed as a limitation to the scope of the present invention. For a proper interpretation of the claim and the present invention the section of ‘Detailed description of the invention’ of this specification should be referred to.

To address the above discussed deficiencies of the prior art, it is a primary object of the present invention to provide a method to eliminate, or at least significantly alleviate, the limitations and drawbacks of the prior art, including those described herein above. Accordingly, a method for paging a MS by a network in a mixed deployment of femto paging areas and macro paging areas in the network is provided. The presence information of the MS is tracked using at least two paging areas when the MS is in a first zone, wherein the first zone is overlapped by a femto paging area and a first macro paging area and the MS is subscribed to a set of CSG femto cells that are allowed for the MS in the femto paging area. The two paging areas are the femto paging area and the first macro paging area. The presence information of the MS is received by the network when the MS moves from the first zone to a second zone, wherein the second zone is overlapped by the femto paging area and a second macro paging area. The network, based on the received presence information, pages the MS only in a subset of the CSG femto cells that are allowed for the MS in the second zone.

This method, features and advantages of the present invention would become more apparent in the ensuing detailed description of the drawings and embodiments of the present invention, which is further limited by the scope of the claims.

### BRIEF DESCRIPTION OF THE ACCOMPANYING DRAWINGS

The following description of the invention would become more apparent when taken in conjunction with the accompanying drawings, wherein:

FIG. 1 illustrates an environment comprising a MS in a mixed deployment of legacy macro PAs and femto PAs in a telecommunication network.

FIG. 2 illustrates an environment, in accordance with the present invention, comprising a MS in a mixed deployment of legacy macro PAs and a femto PA in a telecommunication network, wherein the femto PA is spread over two macro PAs.

FIG. 3 illustrates, in accordance with the present invention, a method for paging the MS when the femto PA is spread over a plurality of macro PAs.

FIG. 4 illustrates, in accordance with the present invention, a method for tracking presence information of the MS.

FIG. 5 illustrates, in accordance with the present invention, a method for mapping the list of macro paging groups to the CSG femto cells.

FIG. 6 illustrates, in accordance with the present invention, a method for location update by a MS in a mixed deployment of legacy macro PAs and a femto PA in a telecommunication network when the MS moves between a plurality of macro PAs under a femto PA.

Persons skilled in the art will appreciate that elements in the figures are illustrated for simplicity and clarity and may have not been drawn to scale. For example, the dimensions of some of the elements in a figure may be exaggerated relative to other elements to help to improve understanding of various embodiments of the present invention.

### DETAILED DESCRIPTION

In the following descriptions of the various embodiments of the present invention, the embodiments are just few of the illustrations the way the methods of the invention can be practiced and thus do not impose any limitation to the scope of the present invention. Further, any relational terms and sequence numbers, like first and second and alike, as may have been used in the description for referring to the accompanying drawings are used to distinguish between two entities without necessarily implying any actual relation between the two entities, unless otherwise specified in the description. The reference numbers, as used in this description, are made unique so that whenever and wherever they are quoted in any part of the description they indicate to only one entity/section of the drawings. Details, as deemed necessary for a proper understanding of the present invention, are only produced here so as not to obscure the description. It is to be understood that various other modifications and enhancements to the present invention, as may be possible without departing from the scope and spirit of the present invention, are all included in the scope of the present invention.

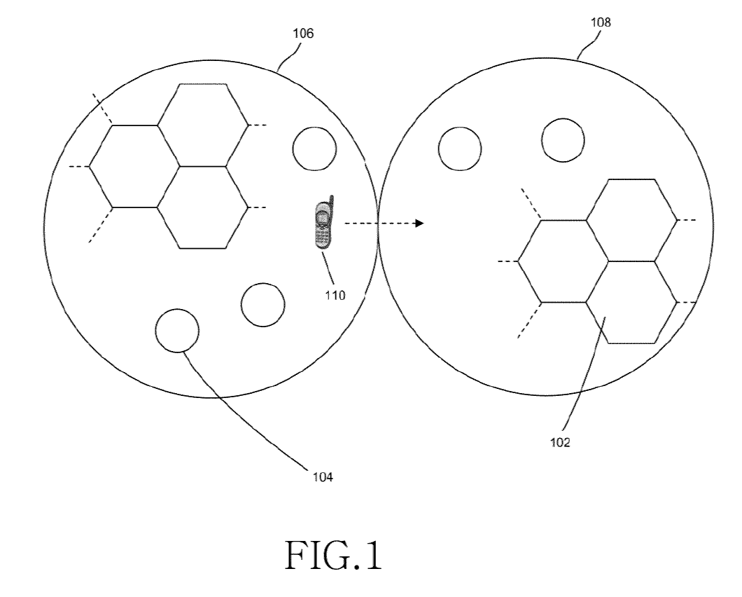

FIG. 1 illustrates an environment comprising a MS in a mixed deployment of legacy macro PAs and femto PAs in a telecommunication network. In the exemplary environment, one or more legacy macro cells, such as 102 and 104, are grouped together to form the macro PAs of 108 and 110 in the network. Each of these macro cells is serviced by one or more BSs. Further, the environment comprises of one or more femto cells. In this example, the femto cells 106(a, b, c, d and e) are non-contiguously spread over the macro PAs 108, 110. Though the femto cells 106, as shown in this example, are distributed non-contiguously across the macro PAs and but they could also be available in a contiguous manner in the network or outside the macro PAs. Further the femto cells 106(a, b, c, d and e) may be either CSG and/or non-CSG in nature for the MS 112. A macro BS is a high power BS which is usually used to cover a larger communication area whereas a femto BS is a low power BS and is typically intended for Home or ‘Small Office Home Office’ (SOHO) usage. The communication device in a network can be either in idle mode or in active mode. The idle mode is designed to reduce the power consumption in the communication device. The communication device in idle mode is tracked by the network using the paging and location update procedures. Examples of communication devices include but are not limited to cell or mobile phones, User Equipments (or UEs), personal digital assistances (PDAs), laptops, computers, etc.

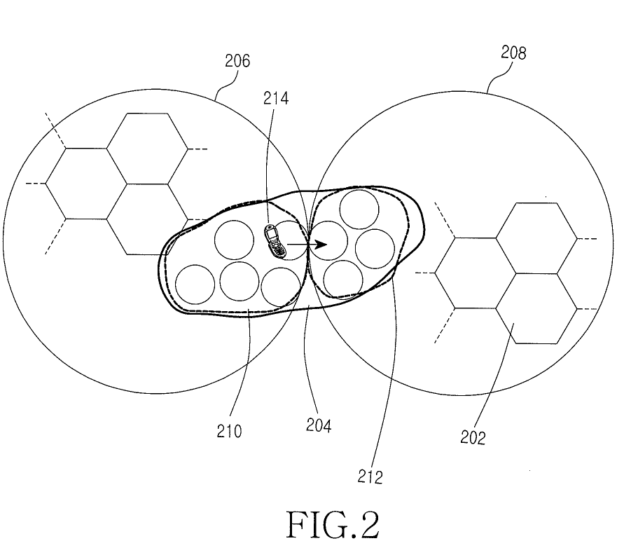

FIG. 2 illustrates an environment, in accordance with the present invention, wherein a MS 214 is in a mixed deployment of legacy macro PAs 206, 208 and a femto PA 210 in a telecommunication network, wherein the femto PA 210 is spread over the two macro PAs 206, 208. The femto PA 210 comprises of a number of femto cells 212(f, g, h, i, j, k, l, m and n). However, the femto cells may be organized geographically in any other manner and need not be limited to only these many numbers. A ‘Paging Group’ (herein after as ‘PG’) is defined as a collection of BSs where all the BSs either belong to femto PA(s) or macro PA(s). A femto PA can be composed of femto cells that are either CSG or non-CSG (non-CSG—also called as ‘Open Subscriber Group’ or ‘OSG’) in nature. Whereas a macro PA can be composed of any types of BSs, including the PSG femto cells, except the CSG femto cells. A PG that is composed of only femto cells 212 (as in this example) is commonly known as the femto PA 210. Considering the example, the femto PA 210 is geographically overlapped by the two macro PAs 206, 208, wherein the portion of the femto PA 210 overlapped by the macro PA 206 can be called as zone 1 214 and the portion of the femto PA 210 overlapped by the macro PA 208 can be called as zone 2 216. Such an environment may commonly arise in case of large enterprise deployments where the enterprise is geographically spread across more than one macro PA.

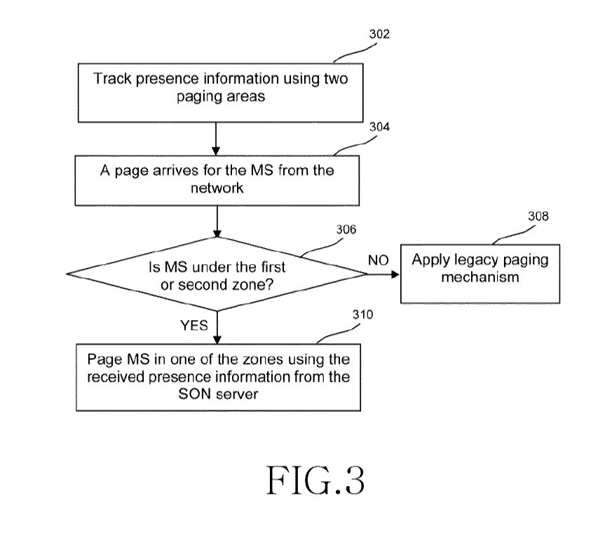

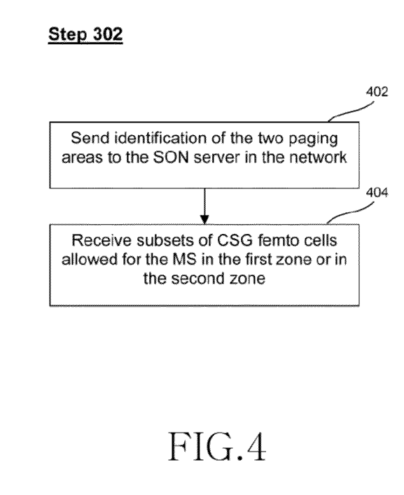

FIG. 3 illustrates, in accordance with the present invention, a method for paging the MS when the femto PA is spread over a plurality of macro PAs. Referring to the exemplary environment of FIG. 2, wherein the MS 218 is in zone 1 214, the network tracks the presence information of the MS 218 using two PAs. An entity in the network, which is usually the ‘Paging Controller’ (herein after as ‘PC’) in the network, is configured to keep track of the femto PA 210 and the macro PA 206 when the MS 218 is subscribed to at least one of the CSG femto cells from the femto PA 210. As in step 402 of FIG. 4, the PC sends an identification, usually the PGIDs, of the two PAs to another entity in the network, known as ‘Self Organizing Network’ (herein after as ‘SON’) server. For example in an IEEE802.16m network, the PC can send the PGIDs to the SON server using a FemtoBSList_Req. The SON server, upon receiving the list of femto cells that are from the zone 1 214 and zone 2 216 and are allowed for the MS 218, figures out the list via its stored mapping and then sends that back to the PC. In an IEEE802.16m network this list of femto cells can be sent using a FemtoBSList_Rsp message. As in step 404 of FIG. 4, the PC then receives the list of allowed CSG femto cells from the SON server. An appropriate request response mechanism can be designed to handle this flow of information.

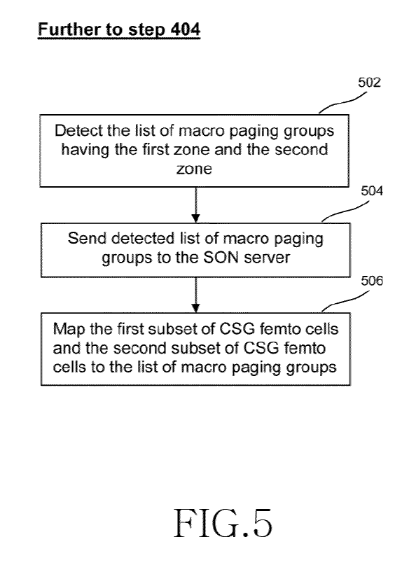

The overlapped paging areas of zone 1 214 and zone 2 216 can also be detected by an entity in the network, which could be by any of the CSG femto cells 212 from the femto PA 210. As in steps 502 and 504 of FIG. 5, the femto cell, upon detecting such overlapped zones, sends the list of macro PGs 206, 208 to the SON server. In one example, the femto cell can detect the overlapped zones during boot up of the femto cell. The SON server, upon receiving information about the overlapped zones, maps the list of macro PGs (214, 216 as per this example) to the set of CSG femto cells 212 in the zone 1 214 and to the set of femto cells in the zone 2 216, as in step 506 of FIG. 5.

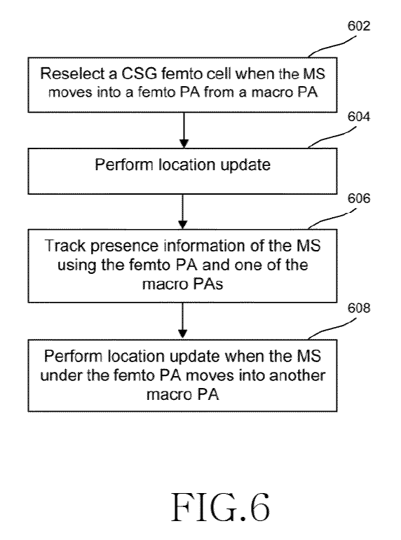

Usually a MS is assigned one or more PAs. This assignment can be implicit or explicit. For example, a MS may assume that it is assigned the PA of a BS in which it entered in idle mode. Subsequently, a MS can assume that it is assigned the PA of the BS in which it performed the location update. Thus, during the cell reselection procedure when the MS 218 detects that the cell that it is reselecting belongs to a PG or a PA that it is not assigned to, the MS 218 performs the location update procedure after reselecting that cell. Assuming that the MS 218 moved into the zone 1 214 from the macro PA 206, the MS 218 reselects a CSG femto cell from the femto PA 210 and updates the network of its location through the normal location update mechanism, as in step 602 of FIG. 6. As in step 606 of FIG. 6, the MS 218 is also tracking the presence information of the MS 218 using two PAs—one being the macro PA 206 and the other being the femto PA 210. This change in MS 218 behavior to monitor the two PAs 206, 210 besides network tracking the presence of the MS 218 in the two PAs 206, 210 enables the MS 218 to report the change in PA of the MS 218 to the network. The MS 218 can check for the macro PA(s) 206 or 208 by searching for the macro cells (202 or 204) and decoding relevant broadcast information from that macro cell that has the highest signal power. Alternatively, any of the femto cells 212 can also broadcast the information of the macro PAs 206, 208 that are overlapping the femto PA 210. The MS 218 on listening to the broadcast information from the femto cell can then detect the overlapping zones, that is, zone 1 214 and zone 2 216. In another embodiment, the femto cell can unicast this information to the MS 218 upon a request made by the MS 218. Referring to the environment of FIG. 2, the network thus receives an update of the presence information of the MS 218 from the MS 218 when the MS 218 moves into the zone 2 216 from the zone 1 214. The network thus updates the presence information of the MS 218 at the granularity of the PA level using the presence information received from the MS 218. As in step 608 of FIG. 6, the MS 218 performs a location update with the network when the MS 218 moves into the zone 2 216 from the zone 1 214. When the MS 218 performs the location update the PC in the network decodes the location update message to check which type of PA is to be updated. For this purpose the location update request message can be enhanced using presence indicators. For example, the location update message can contain a one bit indication to indicate whether the macro PA is to be updated or the femto PA is to be updated for the MS 218.

An example of enhancing the location update message using one bit indicator in an IEEE802.16m system could be:

| Name | Usage |
|---|---|
| Failure Indication | |
| BS Info | |
| >BSID | |
| >Serving/Target Indicator | |
| MS Info | |
| >MSID | |
| Paging Information | |
| >Anchor PC ID | |
| >Anchor PC relocation destination | |
| >Network Exit Indicator | |
| PA to be updated | If Set to 1, it indicates that the |
| | Macro PA is to be updated. |
| | If set to 0, it indicates that the |
| | Femto PA is to be updated. |

Another example of enhancing the location update message using two separate one bit indicators in an EEE802.16m system could be:

| Name | Usage |
|---|---|
| Failure Indication | |
| BS Info | |
| >BSID | |
| >Serving/Target Indicator | |
| MS Info | |
| >MSID | |
| Paging Information | |
| >Anchor PC ID | |
| >Anchor PC relocation destination | |
| >Network Exit Indicator | |
| Macro PA Update | If Set to 1, it indicates that the |
| | Macro PA needs to be updated. |
| | If set to 0, it indicates that the |
| | Macro PA does not needs to be |
| | updated. |
| Femto PA Update | If Set to 1, it indicates that the |
| | Femto PA needs to be updated. |
| | If set to 0, it indicates that the |
| | Femto PA does not needs to be |
| | updated. |

Referring to steps 304 and 306 of FIG. 3, when a page arrives for the MS 218 from the network the network verifies whether the MS 218 is under only a macro PA, such as the macro PAs of 206 and 208 or the MS 218 is in an overlapped zone, such as the zone 1 214 and the zone 2 216. As in step 310, on detecting that the MS 218 is in one of the zones of zone 1 214 and zone 2 216, the network pages the MS 218 in that zone. In accordance with the environment of FIG. 2, the network pages the MS 218 in the zone 1 214. As in step 308, if the network detects that the MS 218 is not in an overlapped zone such as that the zone of zone 1 214 and the zone 2 216, then the network uses the legacy mechanism of paging the MS 218. The network is thus able to save considerable resources in paging the MS 218 only in the overlapped zone of zone 1 214 and by not paging the MS 218 in the whole femto PA 210 when the MS 218 is in the femto PA 210. If the network does not receive a response from the MS after paging the network in an area or a zone (which is zone 1 214 in this example) the network then pages the MS 218 again in the subsequent paging cycles in appropriate PA which could be the femto PA 210 or the macro PAs 206, 208, etc. as per the existing mechanism.

The aforesaid methods and systems can be adapted for, but not limited to, the existing 3GPP and various flavors of IEEE802 systems.

Given the mixed deployment scenario and considering the femtocell as a closed user group, the proposed paging mechanisms help in achieving a balance of paging load and the frequency of location updates in the network.

### GLOSSARY OF TERMS AND DEFINITIONS THEREOF

MS Mobile Station
IEEE Institute of Electrical and Electronics Engineers
BS Base Station
PA Paging Area
PG Paging Group
CSG Closed Subscriber Group
3GPP Third Generation Partnership Project

I/we claim:

1. A method for paging a MS by a network in a mixed deployment of one or more femto paging areas and a plurality of macro paging areas in the network, the method comprising:
tracking presence information of the MS using at least two paging areas when the MS is in a first zone, wherein the first zone is overlapped by a first femto paging area and a first macro paging area, and the MS is subscribed to a set of CSG femto cells in the first femto paging area;
receiving the presence information of the MS when the MS moves into a second zone from the first zone, wherein the second zone is overlapped by the first femto paging area and a second macro paging area; and
paging the MS based on the received presence information.

2. The method according to claim 1, wherein tracking the presence information of the MS using at least the two paging areas comprises:
sending, by a Paging Controller (PC) in the network, an identification of the two paging areas to a Self Organizing Network (SON) server in the network, wherein the two paging areas includes the first femto paging area and one of: the first macro paging area and the second macro paging area;
receiving, by the Paging Controller (PC), one of: a first subset of CSG femto cells allowed for the MS in the first zone and a second set of CSG femto cells allowed for the MS in the second zone from the Self Organizing Network (SON) server.

3. The method according to claim 2, wherein receiving, by the Paging Controller (PC), from the Self Organizing Network (SON) server further comprises:
detecting, by at least a first CSG femto cell from one of: the first zone and the second zone in the network, a list of macro paging groups having the first zone and the second zone;
sending, by the first CSG femto cell, the list of detected macro paging groups to the Self Organizing Network (SON) server; and
mapping, by the Self Organizing Network (SON) server, the first subset of CSG femto cells and the second subset of CSG femto cells to the list of macro paging groups.

4. The method according to claim 1, wherein receiving the presence information of the MS comprises:
receiving a second subset of CSG femto cells allowed for the MS in the second zone.

5. The method according to claim 4, wherein receiving the presence information of the MS comprises:
receiving the presence information of the MS over a location update message.

6. The method according to claim 5, wherein receiving the presence information of the MS through a location update message using one or more presence indicators in the location update message.

7. The method according to claim 1, wherein paging the MS based on the received presence information of the MS comprises paging the MS in the second subset of CSG femto cells allowed for the MS in the second zone.

8. A method for location update of a MS by the MS in a mixed deployment of one or more femto paging areas and a plurality of macro paging areas in a network, the method comprising:
reselecting a CSG femto cell under a first femto paging area when the MS moves into a first zone under the first femto paging area from a first macro paging area, wherein the first zone is overlapped by the first femto paging area and the first macro paging area;
performing a first location update;
tracking presence information of the MS using at least the first femto paging area and one of: the first macro paging area and a second macro paging area, wherein a second zone under the first femto paging area is overlapped by the second macro paging area; and
performing a second location update when the MS moves into the second zone from the first zone.

9. The method according to claim 8, wherein tracking the presence information of the MS comprises:
receiving a broadcast information from the network, wherein the broadcast information includes a set of paging group identities from the second zone.

10. The method according to claim 9, wherein receiving the broadcast information from the network comprises:
receiving the broadcast information over one of: a broadcast and a unicast from the network.

11. The method according to claim 10, wherein receiving the broadcast information over a unicast from the network in response to a request made by the MS to the network.
